(19) United States
(12) Patent Application Publication
(10) Pub. No.: US 2012/0211651 A1
(43) Pub. Date: Aug. 23, 2012

(54) Mass Spectrometer and Method for Direct Measurement of Isotope Ratios

(76) Inventor: John Stephen Vogel, Ukiah, CA (US)

(21) Appl. No.: 13/031,530

(22) Filed: Feb. 21, 2011

(51) Int. Cl. H01J 49/26

(52) U.S. Cl. 250/296

(57) ABSTRACT

An isotope ratio mass spectrometer is described that obtains direct ratios of atomic isotopes in a monoenergetic beam of negative ions by passing them through a collision cell at specific kinetic energies for which the relative production of positive ions from the negative ions is calculable from the isotopic masses.

### CROSS REFERENCE TO RELATED APPLICATIONS

Not Applicable.

### STATEMENT REGARDING FEDERAL SPONSORSHIP

Not Applicable.

### REFERENCE TO LISTING, TABLE, OR APPENDIX Not Applicable.

### TECHNICAL FIELD

This invention relates to a method, design, operation, and application of a mass spectrometer for direct quantification of isotopic abundance ratios without normalization to reference standard materials. The invention describes a transmissive collision cell to normalize isotope ratios continuously through the dependence of ion transmission on velocity and, hence, mass in a monoenergetic ion beam. The invention applies to isotopes of any elements for which a collision cell is used for destruction of molecular ion interference. The method particularly applies to the analysis of radiocarbon abundance in organic materials for determining their radiocarbon “age” or for quantifying the concentrations of ¹⁴C-labeled molecular constituents within biological systems.

### BACKGROUND ART

Isotope ratio mass spectrometry (IRMS) measures isotope ratios using dual inlet ion sources that allow rapid switching between a sampled gas at one inlet with the standard reference gas at the other inlet. This technology is over 60 years old, is well developed, is described in the literature, and is taught by numerous patents including Nier's in 1952, U.S. Pat. No. 2,582,150, and Siok's in 1953, U.S. Pat. No. 2,752,502.

Inductively coupled plasma mass spectrometry (ICPMS) is well known technology for measuring isotope abundance ratios in a range of elements from lithium to uranium. Interfering molecules are removed from ICPMS ion beams using a collision cell, but quantification of isotope abundance requires intermittent samples of standard reference materials to normalize effectiveness of the molecular destruction as taught, for example, in U.S. Pat. No. 7,230,232 by Marriott.

Accelerator mass spectrometry (AMS) extended IRMS to measure isotope ratios of rare isotopes with abundances to 1:10¹⁵, to quantify abundances of long-lived radioisotopes such as radiocarbon (¹⁴C). Purser taught the art of building an AMS instrument in U.S. Pat. No. 4,037,100, further expanding the art in U.S. Pat. Nos. 4,973,841; 5,118,936; 5,120,956; 5,237,174; 5,569,915; 5,621,209; and 5,661,299. Schroeder expanded the art in U.S. Pat. No. 6,815,666.

AMS accelerates selected negative ions of elements and light molecules into a collision cell of a thin solid or rarified gas to effect electron detachment leading to destruction of molecules in the ion beam. The intent is similar to the art of molecular destruction in ICPMS, but molecular isobars in AMS are tightly bound hydrides that require higher collisional energies than in other forms of multi-sector MS. After the multiple electron detachment in the collision cell, positive ions of the isotopes are separated and quantified. The state of the art in AMS is well represented in the literature, particularly from triennial international conferences on AMS with proceedings published in the journal, Nuclear Instruments and Methods in Physics Research, Series B.

IRMS, ICPMS, and AMS heretofore normalized isotope abundances from the measured responses in ion detectors for samples to the responses measured from standard reference materials, while maintaining spectrometer operation as constant as possible between samples and standards. Such mass spectrometers quantify the isotope ratios of the ionized, accelerated, and transmitted ions. Any of these three actions may treat different isotopes differently, giving rise to isotopic fractionation or mass bias that is minimized in measured results by normalizing to standards. There is little mass bias in the ion optics and transports of modern spectrometers, and the origin of mass bias is primarily the ion source. A spectrometer that directly measures isotopic abundances in an ion beam without switching to reference samples in the ion source provides a way to identify and minimize any mass bias from the ion source. Ion sources that have high ionization efficiency fractionate least.

AMS collision energies for electron detachment heretofore were chosen based on one or more of the following criteria: the availability of an existing electrostatic accelerator; the assurance that all molecular isobars are destroyed by electron detachment in the collision cell; the maximization of the fraction of ions entering a particular final charge state; the minimization of the size of the instrument; the limitations on the chosen source of accelerating potential; or the limitations on the chosen means of insulating the collision cell at the accelerating potential.

Transmission of ions through collision cells in AMS differ among isotopes of the same element, but heretofore the loss of charged ions to neutral ions due to electron attachment was not made use of.

AMS heretofore used standard reference samples similar in size to the measured samples to normalize variations that depend on intensity and emittance (angular spread) from the ion source, transport losses through the spectrometer, and background levels in sample preparation.

Gases such as CO₂, used as AMS samples, heretofore required careful control of the pressures and flow rates into ion sources to avoid variations in intensity and emittance from the ion source that affect the measured isotope ratio, with Raatz suggesting a solution in U.S. Pat. No. 5,644,130.

Gas samples to an ion source for IRMS coupled from a chemical separation instrument, such as a chromatograph, heretofore required isotope reference standards for precise quantification of isotopic molecular labels in isolated chemical fractions, as taught by Brand in U.S. Pat. No. 5,424,539. These reference standards were introduced internally within the chemical elution itself, or externally through the insertion of isotope reference standards into the gas stream after the instrument, or by using the classic dual-inlet IRMS method developed in the early 1950's. The arts taught by Koudijs in U.S. Pat. No. 5,438,194 and Hughey in U.S. Pat. Nos. 6,707,035 and 6,867,415 provide only for linking reparatory instruments to AMS without revealing a quantitative mechanism using the detected isotopic ratio.

Isotope dilution mass spectrometry (IDMS) applies IRMS to derive the amount of the sample material by combining an isolated sample of a known isotope abundance with a known amount of material of different isotope abundance. The mixed isotope abundance is compared using reference standards. IDMS heretofore constrained samples and isotope tracers within a narrow dynamic range of the IRMS. IDMS using an AMS heretofore suffered poor accuracy from reference material that was only a few percent different in its isotope abundance from that of the quantified spiked sample, as noted by A. Arjomand, U. Zoppi, and J. Crye in US Patent Application #20100264305.

This invention addresses these deficiencies in the art by measuring ratios among isotopes transmitted through a charge-changing collision cell at specific energies where their transmission probabilities depend fundamentally on their mass. The correction for different transmission factors directly reveals the ratios in the negative ion beam.

### SUMMARY OF INVENTION

### Technical Problem

The invention provides a method, design, and applications of a charge-changing IRMS, similar in many respects to an AMS, in a direct measurement mode without reference to either internal (incorporated within the sample material) or external (a separate sample) measurement of standard reference materials.

### Solution to Problem

The kinetic energy of isotopic ion beams is adjusted to one of several energy ranges in which the fraction of each isotopic ion beam emerging from a collision cell with a particular charge state (the isotope's “transmission”, Tr) is determined from the transmission(s) of one or more other isotopes by a simple factor of the isotopic masses.

In the particular case of negative carbon ions changing charge state from −1 to +1 within a gas collision cell, isotopic transmissions are shown in an illustrative example to follow the specific mass dependent relationships: ¹³C transmission equals ¹⁴C transmission at approximately 600 keV total ion collision energy; and 12 times¹²C transmission equals 13 times ¹³C transmission equals 14 times¹⁴C transmission in a region near 200 keV total ion collision energy. The useful energy regions for other elements and charge states depend on electron affinities and ionization potentials of the elements.

This invention can be employed with multiple embodiments of IRMS, ICPMS, and AMS using an energetic collisional ionization, concomitantly associated with collisional destruction of molecular isobar ions. A direct abundance ratio of isotopes is obtained for constituents of the ion beam incident on the collision cell.

### Advantageous Effects of Invention

Multiple applications of this design and method will be clear to anyone skilled in the art, but include: determination of relative isotopic abundances within isolated samples, measurement of isotopic molecular label concentrations within chemical or physical isolates, chronometric analysis of samples containing natural radioactive isotopes, matrix independent measurement of element concentration in samples using isotope dilution, and metrological quantitation of element concentrations using isotope dilution protocols.

It is an object of the present invention to provide an IRMS combining common magnetic and electric ion selection filters with a collision cell having a velocity-dependent transmission factor such that isotope abundances within a monoenergetic ion beam are obtained without reference to normalizing standard materials.

It is a further object of this invention to describe and define the energy constraints on the monoenergetic ion beam that allow measurement of the direct isotopic abundances within the ion beam.

It is a further object of this invention to provide a method of operating an accelerator IRMS (AIRMS) that directly measures direct abundances of both common stable isotopes and rare radioisotopes in a sample.

It is another object of the invention to provide a method of quantifying isotope dilution measurements over wide concentration ranges using measures of the sample, the diluent, and the diluted mixture, which are not adjusted to similar isotope ratios.

It is yet another object of this invention to provide a continuously quantitative isotope abundance while ion intensity and emittance varies due to sample size or flow of sample material in the ion source using AIRMS.

Features and advantages of the present invention will become apparent from the following description, which includes drawings and examples of specific embodiments, to give a broad representation of the invention. Various changes and modifications within the spirit and scope of the invention will become apparent to those skilled in the art from this description and by practice of the invention. The scope of the invention is not limited to the particular forms disclosed and the invention covers modifications, equivalents, and alternatives falling within the spirit and scope of the invention.

### BRIEF DESCRIPTION OF THE DRAWINGS

FIG. 1 represents the broad and particular components of an accelerator IRMS (AIRMS) and the features of this invention.

FIG. 2a shows detail of one type of negative ion source used with AIRMS, a cesium sputter ion source requiring a solid sample material. FIG. 2b shows detail of one type of negative ion source used with AIRMS, a cesium sputter ion source accepting gas sample material.

FIG. 3 shows hypothetical transmission factors for neighbor mass isotopes differing in mass by 1 amu passing through a collision cell. The potential for operating at an energy for which the transmissions of the two isotopes are equivalent is shown.

FIG. 4 shows hypothetical transmission factors for neighbor isotopes differing in mass by 1 amu passing through a collision cell. The definition of an energy at which the transmissions of the two isotopes are a simple factor of their mass ratio is shown.

FIG. 5 shows the energies and energy regions for which carbon isotope transmissions into the +2, +3, and +4 charge states have simple relation to the isotope masses.

FIG. 6 shows that the product of mass and transmission for ¹³C¹⁺ and ¹²C¹⁺ are equal at collision energies below 210 keV.

FIG. 7 shows that the absolute ¹⁴C¹⁺/¹²C¹⁺ quantification for NIST standard reference material 4990C matches the certified isotope ratio across a wide range of ion source intensities within the precision of counting statistics.

### DESCRIPTION OF EMBODIMENTS

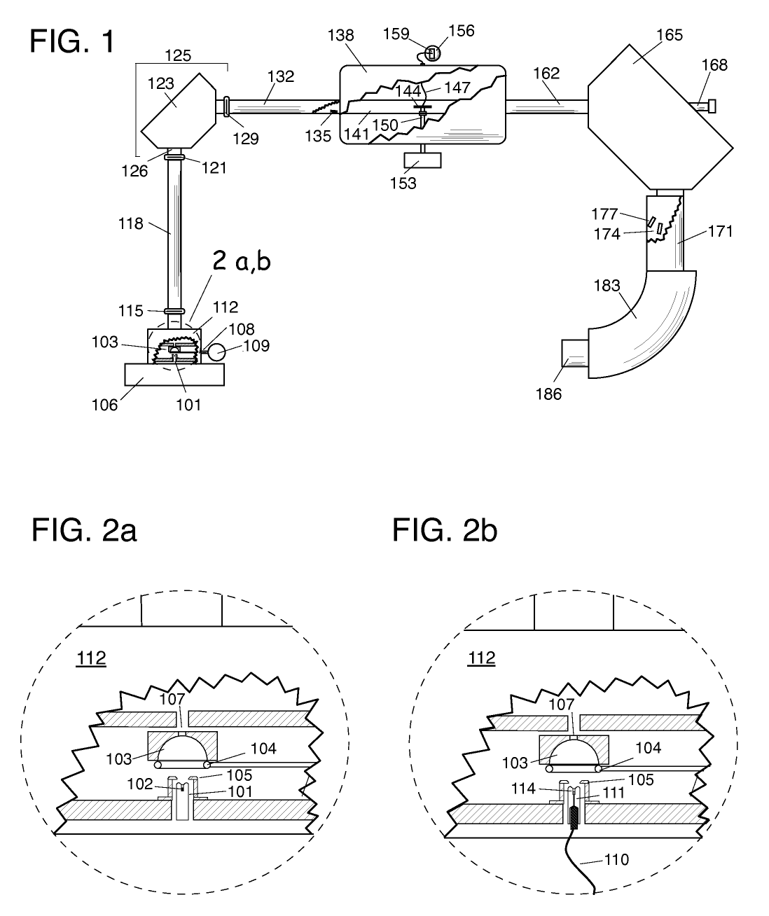

Referring particularly to FIGS. 1 through 5, wherein like numbers refer to similar parts, the invention is described. The general components of the spectrometer are shown in FIG. 1 as a top-down orthogonal view. These components will be familiar to those skilled in the art of IRMS and of AMS in particular. Starting at the source for negative ions (112), which is in this description is a cesium sputter ion source, the path of the ions and the value of certain components is described.

A plentitude of samples, each in their individual holder (101), are arranged within an unspecified sample changing mechanism (106). Any prepared sample is movable into the source from the sample changer 106. Solid sample material in FIG. 2a (102) is recessed from the surface of the holder, which surface itself is recessed further from the front edges of the holder as shown. This arrangement and the placement of the lens element (105) maintains cesium sputtering in a low electric field, minimizing mass bias in ion production. A heated source of cesium vapor (109) connects to a tube (108) to a distribution ring (104) facing a hemispherical ionizer surface (103) that is heated to positively ionize cesium atoms. This ionizer is electrically more positive than the sample, accelerating the positive cesium ions while the hemispherical heater surface (103) and lens (105) focus the cesium on the sample material (102). Negative ions released from the sample accelerate across this potential between sample and ionizer, and static electric fields focus them through the central hole of the ionizer (107). These ion source components are further separated from ground potential by a voltage appearing across the insulator 115 in this representation. Ions emerge at energies of 5 to 50 thousand electron Volts (keV). Another embodiment of the ion source in FIG. 2b uses a thin tube (110) to bring sample gas into a modified holder (111) where the gas is bombarded by cesium ions against a recessed metal anvil (114), releasing negative elemental ions similar to those from a solid sample. Those skilled in the art recognize that the ion source is evacuated and that high voltage potentials are shielded for safety. Ancillary equipment to the described components, such as mounting hardware, vacuum pumps, and power supplies, are not shown throughout this description. Those skilled in the art recognize several ways of maintaining the electric fields of the ion source to produce negative ions of 5-50 keV energies. Those skilled in the art also recognize that other forms of ion sources meet the requirement to produce an elemental ion beam from either solid or gas samples and that this description is illustrative.

The negative ion beam enters an evacuated transport unit (118) containing a series of electrostatic lenses and steering devices (not shown) to focus and center the beam on a defined entrance into a mass selection unit (125) having resolution great enough to fully distinguish ions differing in mass by one atomic mass unit (amu). In this embodiment, the unit comprises a dipole magnet (123) with a vertical field containing an evacuated chamber (126) that is electrically insulated from the magnet pole faces and from the evacuated ion transport units across insulators 121 and 129. A voltage is electrically impressed upon this chamber (126), changing the energy of the entering ions across insulator 121 and returning that same energy to the ions across insulator 129. The impressed voltage is chosen and controlled to bring different mass ions around the 90° path of the chamber in the magnetic field without changing that field. Those skilled in the art recognize that the unit is representative and that similar isolation of one or more ion mass(es) is possible with other arrangements of magnetic and electric fields, such as Wien filters or Brown achromats.

Negative ions selected through this unit (125) enter a transport section (132) that may contain electrostatic lenses and/or steering plates (not shown) that center and focus selected ion beams on the axis of a collision cell (144) that is held at a chosen accelerating voltage supplied by either mechanical or electronic means (153), which voltage is transmitted (150) to the collision cell within an isolating and/or insulating volume, here shown as a tank (138). A Faraday cup (135) allows the measurement of the current in an ion beam prior to the selected ions being accelerated toward the collision cell by moving the Faraday cup onto the axis of transport or by maintaining it off-axis at a position chosen to intercept a desired ion beam. All transport of the ions to the acceleration stage at the entrance to 138 occurs in evacuated paths. Ion losses to collisions with residual gas decrease efficiency of transport, but do not cause mass bias, since single electron detachment at these ion energies is the dominant loss mechanism, is constant with ion velocity, and is hence independent of ion mass.

Volume 138 may electrically insulate the collision cell 144 using air in one embodiment, in which case volume 138 is a safety cage. The insulation may be pressurized gas in another embodiment, and volume 138 is a pressure vessel. In either case, the ions are provided an evacuated path to and from the gas collision cell 144 through a columnar tube (141). In the preferred embodiment, the collision cell 144 is isolated and insulated by vacuum, in which case volume 138 is evacuated and a specific transport tube (141) is not required. The ends of the collision cell (144) are open to either the evacuated volume of 138 or the evacuated transport tube 141, and a continuous flow of gas is brought to the collision cell 144 by a thin tube (147) leading to a gas regulator (159) on a supply tank of gas (156) which is located either external or internal to volume 138. An equilibrium between the loss of collision gas to the vacuum and the controlled regulation of the supply effects a constant gas thickness through the collision cell 144. The gas can be hydrogen, nitrogen, oxygen, or any of the noble gases. The preferred embodiment using vacuum insulation within 138 allows large vacuum pumps to maintain good vacuum along the ion path through volume 138, minimizing ion-gas interactions except within the controlled collision cell (144). Those skilled in the art recognize that the collision cell may consist of thin solid foils or other forms of low-density collision materials instead of gas.

Negative ions having keV energies from the ion source gain the additional energy determined by the potential on the collision cell 144, acquiring the collision energy,

E₀=E_{source}+E_{cell} Math. 1

between the ion and the material confined in the collision cell. The collisions detach electrons from ions in a velocity-dependent manner, producing neutral or positive ions. Single collisions at high energies and multiple collisions at lower energies remove binding electrons from molecular ions, dividing any molecules into component atoms. These no longer have the same mass and energy as the atomic ions chosen in mass selector 125 and are distinct in subsequent ion analysis.

The “transmission” of an ion is the fraction of incident negative ions that emerge from the collision cell with a particular positive charge. Velocities of the negative atomic ions determine the average positive charge state of ions emerging from the collision cell. The isotopic ions have the same collision energy, but different velocities, producing different transmissions for the isotopes of the sampled element. A fraction of the ions emerge as neutral ions with no net charge, and this fraction also depends on ion mass.

Positive ions from the collision cell 144 in embodiments insulated by vacuum or pressurized gas obtain further acceleration as they proceed to a lower potential on the base structure of the analysis unit through the transport (162) which may contain ion monitoring or focus devices (not shown). Air-insulated embodiments maintain the base of the ion selection unit at the same potential as the collision cell or have the subsequent ion analysis units based at the potential of the collision cell within the safety cage. In yet another embodiment, the collision cell (144) may be electrically associated with an insulated vacuum chamber within the first analysis magnet 165. Positive ions from the collision cell do not obtain further energy in air-insulated embodiments. In all cases, equally charged positive isotopic ions have the same kinetic energy with differing velocities entering the analysis unit, which magnetic and/or electrostatic sector(s) separate them into isolated measurable ion beams.

The preferred embodiment uses magnet 165 to analyze isotopes of lowest mass into the outermost Faraday cup (177) of an evacuated chamber (171), with heavier isotopes stopping in one or more Faraday cups (174) lying closer to the magnet axis. As in multi-collector IRMS and ICPMS, any number of Faraday cups may be arrayed along the magnet's (165) focal plane but must have entrance apertures large enough to capture an ion beam without accepting ions of nearby masses. Isotopes with very low abundance, such as radioisotopes, are directed into further stages of ion isolation, such as a spherical electrostatic analyzer (183), before they are individually detected in an ion counter (186). The aperture of the ion counter for rare isotopes has similar open area as the Faraday cups.

Count rates from any ion counter and the ion currents from the Faraday cups are processed electronically (not shown) and recorded for analysis in computers (not shown). Those skilled in the art recognize that multiple arrangements of magnetic and/or electric fields can achieve similar ion separation and quantification. Those skilled in the art further recognize that the analyzer(s) represented by 183 and the single ion counter (186) are not required in systems that measure only abundant isotopes.

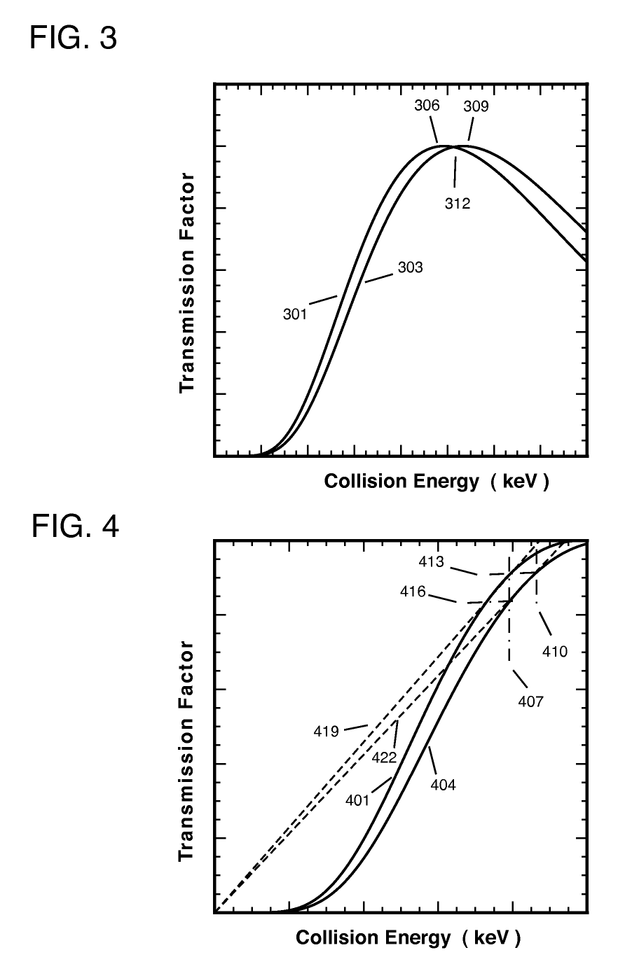

The measured ratio of isotopes is the ion beam intensity of one isotope, measured as count rates from an ion counter or as current in a Faraday cup, divided by the ion beam intensity of another isotope, with suitable fundamental constants used to relate ion count rate and ion current. This measured ratio is then corrected for the difference in transmission factors between the isotopes. This is made more clear in reference to FIG. 3, in which the transmission factor of an isotope as a function of collision energy is exemplified by the curve (301). An isotope that is one mass unit heavier has a transmission factor equal to that of the lower mass isotope (301) at a higher energy for which the isotope velocities are equal, as shown by curve 303 in FIG. 3. The described spectrometer causes all isotopes to have the same collision energy. As this energy increases, both transmission factors increase until the next higher charge state dominates production of positive ions, at which point the transmission factors decrease, revealing a specific energy of maximum transmission of the chosen positive charge state for each isotope (306, 309). Between the maximum transmissions of the two isotopes lies an energy (312) at which the transmissions of the two isotopes are equal. This energy (312) defines an operating collision energy for which the transmission factors for both isotopes are equal and for which the ratios of positive ion intensities reproduces the ratio of the isotopes in the negative ion beam.

At other specific collision energies, the transmission factors of two isotopes are related by simple functions of their masses, for example m and n, as demonstrated in FIG. 4, where the transmission of two isotopes having masses different by 1 amu are shown as the curves 401 and 404 in which the transmissions are equivalent (413) at one energy of the low mass isotope (407) and at a higher energy (410) of the heavier mass isotope equal to energy 407 times the ratio of the high to low masses. Lines drawn to equivalent transmission (413) from the origin have slopes for line 419 of (T₄₁₃/E₄₀₇) and for line 422 of (T₄₁₃/E₄₁₀). Since energy 410 equals energy 407 times n/m, it follows that the transmission of the more massive isotope, n, has transmission (416) at operating energy 407 given by (m·T₄₁₃/n). Thus, the measured isotope ratio is corrected for this known difference in transmissions to obtain the absolute isotope abundance ratio in the ion beam from the source. This property is valid for any region in which the tangent to the transmission-versus-energy curve passes through the plot origin. In such an energy region, the transmission factors (Tr) of two isotopes, m and n, bear the relation:

m·Trₘ=n·Trₙ Math. 2

to a precision limited by the curvature of the transmission factor in that energy region.

The absolute isotope ratio, R, of a sample measured at this defined collision energy is found from the measured isotopic ion intensities, I, corrected by their transmissions:

R=(Iₙ/Trₙ)/(Iₘ/Trₘ)=(Iₙ/Trₙ)/(m/(n/m)·Trₙ)=(n/m)·(Iₙ/Iₘ) Math. 3

where n and m are the isotopic masses. This is extended to 3 or any number of isotopes, as long as the region of the transmission curves between 413 and 416 is approximated by a straight line within the desired precision of the isotope ratio measurements. In another embodiment, collision energies are synchronized with the isotope selection unit (125) by varying the voltage on the collision cell and on the vacuum chamber within the analyzing magnet to maximize measurement precision for ratios of successive pairs of isotopes.

A quantifying detector for neutral ions (168) is placed on the axis of the collision cell after the first mass analysis stage (165). This detector allows precise setting of the steering mechanisms within 118, 132, and the isotope selection unit (125) by minimizing variation in the detected neutral ion beam so that each selected isotopic ion beam is centered on collision cell 144.

### EXAMPLE 1

### Carbon Isotopes

The preferred embodiment is well suited to quantify concentrations of ¹⁴C and ¹³C against the dominant isotope ¹²C in natural materials for determining carbon dates and natural chemical pathways of archeological, geological, and oceanographic samples. Carbon isotopes are also well suited for tracing isotope-labeled forms of chemicals through living systems, including humans. The invention is therefore further defined and described by this illustrative example showing that the less abundant carbon isotopes are quantified absolutely against the common isotope using the design and method described above. The example is provided for further understanding and appreciation of the utility of the invention and does not restrict the scope of invention. Those skilled in the art will recognize the modifications in operation and methods required to apply the invention to other elements and isotopes.

Carbon samples are ionized by a cesium-sputter ion source most efficiently in the form of a carbon fullerene precipitated from an iron-group catalyst by reduction of CO₂, first described by Vogel and others during 1984 in “Performance of catalytically condensed carbon for use in AMS” published by Nucl. Inst. Meth. (volume B5, page 289) and further taught by Vogel's U.S. Pat. No. 7,611,903. Ten microgram to 10 milligram (mg) amounts of carbon so converted to fullerene on 1-50 mg of iron or cobalt powder are pressed into sample holders (101) forming a pellet (102) that is sputtered and negatively ionized in the ion source, 112. The negative ions are accelerated to 40 keV within the ion source and across 115. Mass selector 125 repetitively selects an ion mass from the group (12, 13, and 14 amu) around the 90° bend of magnet 123 in rapid succession, with most time selecting mass 14 (e.g. 100 milliseconds, ms), less time selecting mass 13 (e.g. 5 ms), and shorter time selecting the high intensity beam of mass 12 (e.g. 0.05 ms). The vast plurality of mass 14 ions consist of ¹²CH₂⁻ and ¹³CH⁻ and a plurality of the mass 13 ions consist of ¹²CH⁻. With the collision cell held at positive 160 kV, for example, the ions have 200 keV energy at the collision cell (144) and strike either gas or solid target atoms, converting 35-45% of the negative carbon ions to positive ions with a single charge. 30-40% of the ions emerge from the cell with no net charge. The positive ions further accelerate from the collision cell, attaining energies of 360 keV, with the neutral ions remaining at 200 keV energy.

Charged ions are analyzed in dipole magnet 165 where lower momentum debris ions from molecular dissociation are lost to the side walls of the magnetic analyzer 165. Neutral ions are unaffected by magnet 165 and impinge on the detector axially aligned with the collision cell designed to quantify them (168). The position of Faraday cup (177) is adjusted to intercept mass ¹²C⁺ ions, with the electric intensity striking the cup quantified through known methods of amplification and integration prior to computer-based storage and analysis. Similarly, the position of Faraday cup (174) is adjusted to intercept ¹³C⁺ ions with the electric intensity striking the cup quantified through known methods of amplification and integration prior to computer-based storage and analysis. The ¹⁴C⁺ ions proceed through chamber 171 into a spherical electrostatic energy analyzer (183). The analyzer rejects ions of lower mass that have correct momentum for a 90° bend through magnet 165 but do not have the same energy as ¹⁴C ions. The ¹⁴C⁺ ions are detected individually by their loss of energy in a suitable detector (186) that quantifies the rate of count arrivals using known amplifiers and counting circuits prior to computer-based storage and analysis. The intensities of the three beams of mass-identified ions are quantified as electric currents for ¹²C and ¹³C and in counts-per-second (cps) for ¹⁴C, which is converted to a current knowing that each ion carries one positive charge of 1.6022×10⁻¹⁹ Coulomb, or 0.160 attoAmp/cps (“atto”=10⁻¹⁸).

AMS spectrometers place samples sequentially into ion source 112 from a storage and selection mechanism (106) and record the intensities of the ion beams for a suitable time that is determined by statistical precision desired in counting the ¹⁴C. A sample of a standard reference material is measured regularly throughout the process of measuring other samples (e.g. once every 5-10 samples) in the traditional art. These reference materials have well-established ¹³C and ¹⁴C isotopic abundances, such as U.S. NIST SRM 4990 C Oxalic acid (“Ox2”) radiocarbon standard (¹³C=1.1037% ¹²C, ¹⁴C=1.606×10⁻¹²¹²C) and IAEA C6 sucrose (¹³C=1.1116% ¹²C, ¹⁴C=1.777×10⁻¹²¹²C) and are suitable for proving the correct operation of this invention.

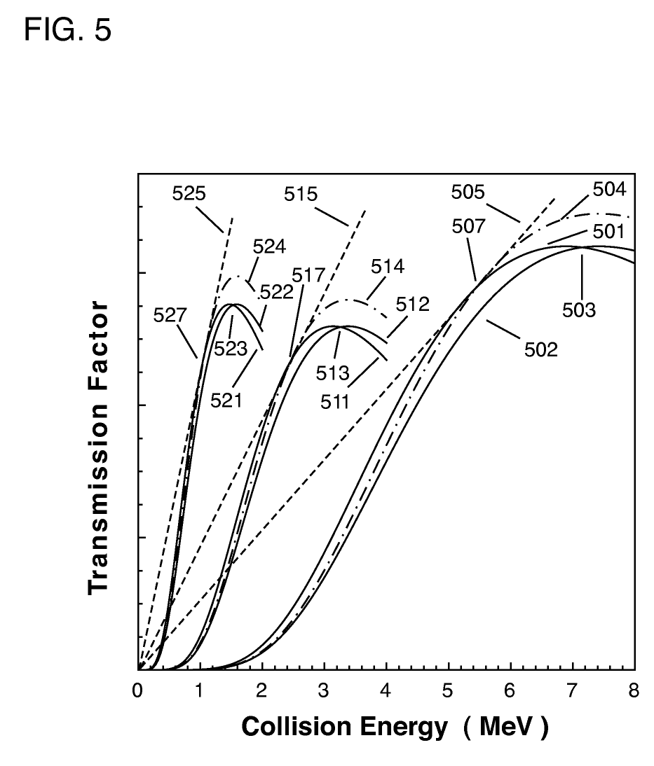

Following the above description of concepts in FIG. 4 and now referring to FIG. 5, the transmission factor for ¹³C⁻ ions losing 5 electrons in collision cell 144 to become ¹³C⁴⁺ ions is shown by curve 501 which well fits published data. Similarly, curve 502 represents the transmission factor for ¹⁴C⁴⁺ ions from ¹⁴C⁻ as a function of collision energy. An energy for which the transmission factor of ¹⁴C⁴⁺ equals that of the ¹³C⁴⁺ is apparent at 7.2 MeV (503). An energy for which the transmission factor of ¹⁴C⁴⁺ equals (13/14) times that of the ¹³C⁴⁺ can be found one of two ways:
a. a straight line (505) is drawn from the origin of the plot to a point (507) tangent to the transmission curve (501), at which energy (5.5 MeV, 507) transmission factors of neighboring isotopes can be derived from their masses as described above in relation to FIG. 4;
b. curve 502 is multiplied by (14/13) and plotted as curve 504, revealing the same energy region 5.5 MeV, 507) for which the transmission factors to ¹³C⁴⁺ and ¹⁴C⁴⁺ are related as 14·Tr₁₄ equals13·Tr₁₃.

Similarly, curve 511 well represents the transmission factor through an AMS for ¹³C³⁺ with the line 515 from the plot origin defining an energy (2.5 MeV, 517) for which transmissions of neighboring isotopes are related by the ratios of isotopic masses. Curve 512 representing the ¹⁴C³⁺ transmission shows the energy (3.3 MeV, 513) at which the transmissions of ¹⁴C³⁺ and ¹³C³⁺ are equal. Multiplying curve 512 by (14/13) yields curve 514, confirming that ion energies in the region around point 517 have transmission factors of ¹³C³⁺ and ¹⁴C³⁺ related as 14·Tr₁₄ equals13·Tr₁₃. Curves 511, 512, and 514 have been truncated at 4 MeV for clarity of illustration, but trend toward lower transmission at higher energies.

Similarly, curve 521 represents the transmission factor through an AMS for ¹³C²⁺ with the line 525 from the plot origin defining an energy (1.1 MeV, 527) for which transmissions of neighboring isotopes are related by the ratios of isotopic masses. Curve 522 representing the ¹⁴C²⁺ transmission shows the energy (1.5 MeV, 523) at which the transmissions of ¹⁴C²⁺ and ¹³C²⁺ are equal. Multiplying curve 522 by (14/13) yields curve 524, confirming that ion energies in the region around point 527 have transmission factors of ¹³C²⁺ and ¹⁴C²⁺ related as 14·Tr₁₄ equals13·Tr₁₃. Curves 521, 522, and 524 have been truncated at 2 MeV for clarity of illustration, but trend toward lower transmission at higher energies.

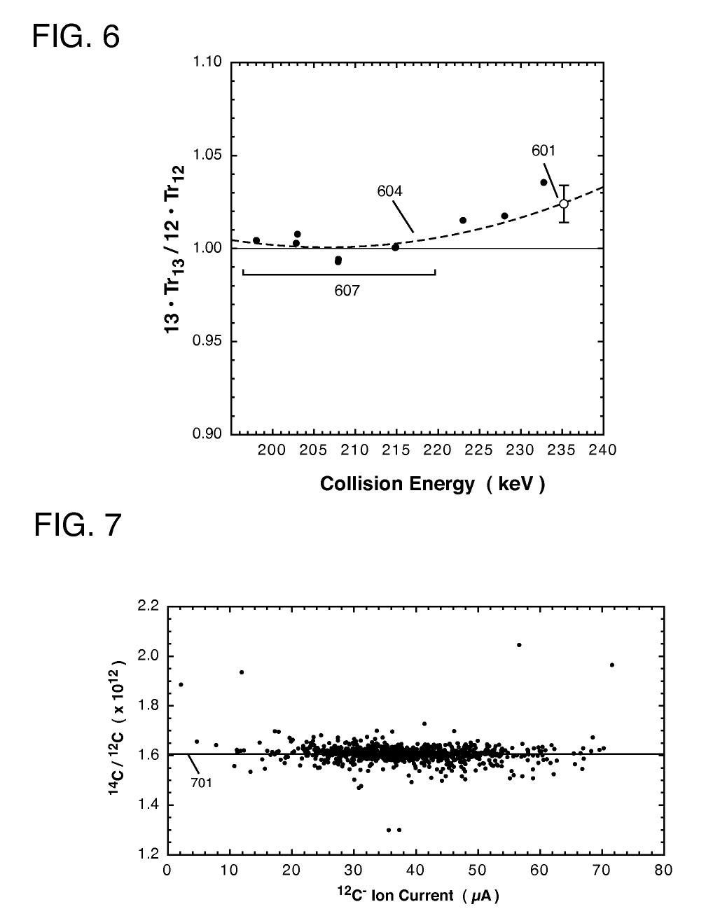

The transmission factor to C¹⁺ from C⁻ are less well known and the energy at which absolute carbon isotope ratios can be measured was found by experiment. Operation of an AMS as described by FIG. 1 showed that 14·Tr₁₄ equals13·Tr₁₃ at a collision energy of 235 keV for NIST SRM4990C, Ox2. However, 12·Tr12 was 2.4% lower than 14·Tr₁₄ and 13·Tr₁₃ at that energy. The collision energy of C⁻ was tested at lower values and the ratio of 13·Tr_{13/12}·Tr₁₂ plotted against collision energy in FIG. 6 by solid data points. The average measurement for 875 measurements for Ox2 taken over a period of 1 year at 235 keV energy is also shown (601) at 2.4% too high for the known ¹³C/¹²C ratio of this material. A quadratic fit (604) of the data is plotted. A region of collision energies, 607, is identified over which the ratio 13·Tr₁₃/12·Tr₁₂ is 1.0005±0.0053.

Operating a spectrometer at a collision energy of 210 keV, within region 607, the carbon isotope transmission factors are found to follow the relation derived above:

14·Tr₁₄=13·Tr₁₃=12·Tr₁₂. Math. 4

The isotope ratio of a sample is thus quantified by the electric current ratio of the positive ions multiplied by ratio of the isotope masses:

(¹³C/¹²C)_{measured=}13·I₁₃/12·I₁₂ Math. 5

(¹⁴C/¹²C)_{measured}=14·I₁₄/12·I₁₂ Math. 6

with the result that the average absolute ¹³C/¹²C ratio measured 50 times each for four samples of Ox2 over 6 hours is (1.1071±0.0035) %, in agreement with the NIST value of 1.1037%. Twenty one measures of IAEA C6 reference material averaged ¹³C/¹²C to (1.1115±0.0098) %, in agreement with the accepted 1.1116%. Five hundred and seventy five absolute measures of the ¹⁴C/¹²C ratio for Ox2, as shown in FIG. 7, taken to a precision of at least 1% each (>10,000 ¹⁴C counts), average to (1.610±0.016)×10⁻¹² in agreement with the NIST value of 1.606×10⁻¹² (701) within the expected 1% precision These 575 measures of the absolute ¹⁴C/¹²C ratio for Ox2 occur over a 1 year period under different spectrometer conditions, specifically variations in ion source intensity spanning 5 to 75 μA ¹²C⁻ ion intensity. A linear regression reveals no significant correlation of isotope ratio with ion intensity, the condition that allows continuous isotope ratio measurements from ion sources that have varying intensity.

In this example, we show 4 ways (direct crossover, tangent line to origin, crossover of scaled curve, and systematic search) to find an ion collision energy for which absolute carbon isotope ratios are measured in an AIRMS and show that accurate absolute ratios for NIST SRM 4990C and IAEA C6 are found for ¹³C/¹²C and ¹⁴C/¹²C. Physical principles suggest that other collision energies may exist for transmission from C⁻ to C¹⁺ at which the tangent to the transmission curve passes through the origin, permitting further embodiments of the invention. Those skilled in the art recognize that improvements to the ion source and spectrometer can be made in the spirit of this invention to achieve even better precision and accuracy than demonstrated here.

### EXAMPLE 2

### Absolute Isotope Dilution Mass Spectrometry

The preferred embodiment is well suited to quantify the amount of a chemical component that has a specific isotope concentration when it is mixed with a chemical component that has a different isotope concentration, an isotope dilution mass spectrometry (IDMS) analysis. The invention is further defined and described by this illustrative example showing that the less abundant carbon isotopes provide a utility for the invention in quantifying mixed components by IDMS despite wide abundance differences. The example is provided for further understanding and appreciation of the utility of the invention and does not restrict the scope of invention to illustrated methods, elements, and isotopes. Those skilled in the art will recognize the modifications in operation and methods required to apply the invention to other analyses, elements, and isotopes.

Measurement of ¹⁴C concentration in chemically or physically isolated samples occurs in multiple fields of endeavor, from carbon dating artifacts for archaeology to tracing isotope-labeled pharmaceutical candidates within biopsies of human subjects. The more specific the isolation, the more reliable and valuable the measured concentration becomes. AMS quantifies low levels of ¹⁴C from small amounts of chromatographic eluates, for example, with the addition of a carrier compound to provide more carbon mass for transport and introduction of the sample into the ion source. However, the amount of isolated sample may not be measurable within the confines of the chemical elution or the sensitivity of non-destructive analysis. Thus, the true concentration of ¹⁴C per unit mass or volume of sample is indeterminant.

AMS spectrometers that use direct power supplies (153) to place low (<300 kV) accelerating voltage on the collision cell 144 hold that voltage despite a large current pulse of ¹²C, allowing an accurate measurement of ¹³C/¹²C as well as ¹⁴C/¹³C of the positive transmitted ions. The AMS described in FIG. 1, used at collision energies found in the manner specified above, accurately quantifies absolute isotope ratios over many orders of magnitude without normalization, removing constraints on choices of isotope diluent compounds. If the carrier compound is depleted in both ¹⁴C and ¹³C, isotope dilution determines both the amount of ¹⁴C and the carbon mass of the sample to provide an accurate ¹⁴C concentration measurement. This art of IDMS is well known but heretofore required that the sample, the carrier, and the mixture have similar isotope concentrations that were normalized by standard reference materials across a calibrated range. Further, diluents depleted in ¹³C are seldom used in IDMS because of restricted dynamic range in the diluted sample. Depleted diluents are well suited for AIRMS IDMS because diluent carriers are commonly added in large mass excess (factors of 10 to 1000) to the sample amount for optimal operation of the ion source. Diluting 10 μg natural carbon (9 nmol ¹³C from 1.1% ¹³C) with 1 mg 99.9% ¹²C diluent (83 nmol ¹³C) provides a 3% precision measurement of the 10 μg sample mass if the precision of the AMS measurement remains as quoted above for the reference measurements. The mass of the ¹²C in the sample, M_{S}, is derived from the ¹²C diluting mass, M_{D}, and the absolute isotope ratios, R, for the sample, Rₛ, diluent, R_{d}, and resultant mixture, Rₘ, in the familiar isotope dilution equation:

M_{S}=M_{C}·(Rₘ−R_{d})/(Rₛ−Rₘ) Math. 7

Recalling that the absolute isotope ratio, R, for ¹³C/¹²C is just the ratio of the ion currents measured by the AIRMS, S=I₁₃/I₁₂, times a constant (13/12), the IDMS equation reduces to a relation involving only the ratios of ion currents:

M_{S}=M_{D}·(Sₘ−S_{d})/(Sₛ−Sₘ) Math. 8

The total carbon mass, W, of the sample is obtained by adding in the requisite mass of ¹³C in the sample:

W_{S}=M_{S}·(1+13*R_{S}/12) Math. 9

An advantages of IDMS with AIRMS is that the sample sizes and currents of the sample, mixture, and diluent need not be similar, since the transmissions of respective isotopes at the appropriate collision energy correlate well across wide current ranges, as shown in Example 1.

Citation List
U.S. Pat. Nos.

| | |
|---|---|
| 2,582,150 | Nier |
| 2,752,502 | Siok |
| 4,037,100 | Purser |
| 4,973,841 | Purser |
| 5,118,936 | Purser |
| 5,120,956 | Purser |
| 5,237,174 | Purser |
| 5,438,194 | Koudijs |
| 5,569,915 | Purser |
| 5,621,209 | Purser |
| 5,644,130 | Raatz |
| 5,661,299 | Purser |
| 6,707,035 | Hughey |
| 6,815,666 | Schroeder |
| 6,867,415 | Hughey |
| 7,230,232 | Marriott |
| 7,611,903 | Vogel |

U.S. Pat. Appl.

| | |
|---|---|
| 20100264305 | Arjomand |

### Other

Vogel, J. S., Brown T. A., Southon J. R. and Nelson D. E. (1984) Performance of catalytically condensed carbon for use in AMS. Nuclear Instruments and Methods B v. 5, p. 289.

What is claimed is:

1. An isotope ratio mass spectrometer (IRMS) measuring direct isotope ratios for common stable isotopes and/or low-concentration radioisotopes comprising:
a. A source of monoenergetic negative elemental ions from a defined solid or gaseous material emitting such ions with minimal or constant differences among the production efficiencies for each isotope of a chosen element;
b. A set of components creating electrostatic fields that concentrate and steer the negative ions from the source at a specific kinetic energy into a defined ion beam that enters the central axis of:
c. A unit comprising a single or series of magnetic field(s) that separate(s) the negative ions into beams having specific masses with mass resolution of at least one amu, which unit also contains:
d. Electrostatic components that permit sequential or continuous selection of a single or set of ion mass(es) emerging concentrically aligned to and focused on the central axis of:
e. A defined volume (“cell”) of low density solid or a gas comprising hydrogen, nitrogen, oxygen or one of the noble gases, in which single and multiple collisions of the negative ions with the collision target molecules results in multiple electron detachment from, accompanied by electron attachment to, the selected negative ions resulting in neutral and positive ions, which cell volume is maintained at:
f. A specific electrostatic potential energy with respect to the ion-selection unit such that production of a specific positive charge state at the exit of the collision cell follows the relation among the various selected isotopic masses of the desired element described by:
g. The fraction of incident negative ions of one isotope emerging as ions in a specific positive charge state (“transmission fraction”) equals the transmission fraction of incident negative ions of another isotope, when the transmitted ions are analyzed by:
h. A series of magnetic and/or electrostatic fields capable of isolating without differential losses among the positive ions produced in the collision cell according to their atomic masses and their net electric charges prior to:
i. A set of quantifying detectors of the positive ions isolated according to individual ion mass and charge that comprises:
j. The complete capture of macroscopic ion currents in Faraday Cups feeding amplifiers and integrators for common stable isotopes of the sampled element, and/or:
k. The counting of individual positive ions of low-abundance rare isotopes using one of any of a number of possible ion counters, including ionization detectors, secondary electron multipliers, channeltrons, or similar instruments read out by electronic systems that are fully corrected for non-linear responses in count rate, with the results analyzed by:
l. Deriving the isotope ratio of a pair of isotopes by dividing the quantified current or count rate of one isotope by the quantified current or rate of the other isotope using appropriate fundamental conversion factors to relate count rates with electric currents.

2. An isotope ratio mass spectrometer (IRMS) measuring direct isotope ratios for common stable isotopes and/or low-concentration radioisotopes comprising:
a. A source of monoenergetic negative elemental ions from a defined solid or gaseous material emitting such ions with minimal or constant differences among the production efficiencies for each isotope of a chosen element;
b. A set of components creating electrostatic fields that concentrate and steer the negative ions from the source at a specific kinetic energy into a defined ion beam that enters the central axis of:
c. A unit comprising a single or series of magnetic field(s) that separate(s) the negative ions into beams having specific masses with mass resolution of at least one amu, which unit also contains:
d. Electrostatic components that permit sequential or continuous selection of a single or set of ion mass(es) emerging concentrically aligned to and focused on the central axis of:
e. A defined volume (“cell”) of low density solid or a gas comprising hydrogen, nitrogen, oxygen or one of the noble gases, in which single and multiple collisions of the negative ions with the collision target molecules results in multiple electron detachment from, accompanied by electron attachment to, the selected negative ions resulting in neutral and positive ions, which cell volume is maintained at:
f. A specific electrostatic potential energy with respect to the ion-selection unit such that production of a specific positive charge state at the exit of the collision cell follows the relation among the various selected isotopic masses of the desired element described by:
g. The fraction of incident negative ions of one isotope emerging as ions in a specific positive charge state (“transmission fraction”) equals the transmission fraction of incident negative ions of another isotope multiplied by the ratio of the atomic mass of the second isotope to the atomic mass of the first isotope, when the transmitted ions are analyzed by:
h. A series of magnetic and/or electrostatic fields capable of isolating without differential losses among the positive ions produced in the collision gas volume according to their atomic masses and their net electric charges prior to:
i. A set of quantifying detectors of the positive ions isolated according to individual ion mass and charge that comprises:
j. The complete capture of macroscopic ion currents in Faraday Cups feeding amplifiers and integrators for common stable isotopes of the sampled element, and/or:
k. The counting of individual positive ions of low-abundance rare isotopes using one of any of a number of possible ion counters, including ionization detectors, secondary electron multipliers, channeltrons, or similar instruments read out by electronic systems that are fully corrected for non-linear responses in count rate, with the results analyzed by:
l. Deriving the isotope ratio of a pair of isotopes by dividing the quantified current or count rate of one isotope multiplied by its atomic mass by the quantified current or rate of the other isotope multiplied by its atomic mass, using appropriate fundamental conversion factors to relate count rates with electric currents.

3. An IRMS described in claim 1 or claim 2, in which the element under study is carbon.

4. An IRMS described in claim 3, in which the pair of isotopes is ¹⁴C and ¹³C.

5. An IRMS described in claim 3, in which the pair of isotopes is ¹⁴C and ¹²C.

6. An IRMS described in claim 3, in which the pair of isotopes is ¹³C and ¹²C.

7. An IRMS described in claim 2, in which the three isotopes, ¹²C, ¹³C, and ¹⁴C, are quantified at an energy in the collision cell for which their transmission factors, TF, follow the relationship:
12·TF₁₂=13·TF₁₃=14·TF₁₄. Math. 10

8. An IRMS described in claim 1 or claim 2, in which an array of Faraday cups are arranged along the focal plane of a magnetic separator of positive ions for quantifying multiple ion beams of stable isotopes of an element.

9. An IRMS described in claim 1 or claim 2, in which a quantifying detector of energetic neutral ions is placed in axial alignment with the collision gas cell after the first magnetic field component of the ion analysis unit.

10. An IRMS described in claim 1 or claim 2, in which samples of the chosen element have a range of material amounts, producing a range of negative ion intensities from the source for which isotope abundances are quantified.

11. An IRMS described in claim 1 or claim 2, which uses an inlet of the ion source to introduce gaseous forms of the sample material and provides continuous quantification of isotope ratios in the emitted ion beam.

12. An IRMS described in claim 11, in which the sample material enters as carbon dioxide.

13. An IRMS described in claim 1 or claim 2 that quantifies isotope dilutions for the comparisons of unknown amounts of isotopically natural substances against known amounts of isotopically modified materials.

14. An IRMS described in claim 13 that quantifies amounts of sample material having natural ¹³C concentrations with respect to ¹²C using isotopic dilutants with depleted concentrations of ¹³C.

15. An IRMS described in claim 14 that further quantifies the concentrations of ¹⁴C with respect to ¹²C within defined sample materials in the same measurement.

16. An IRMS described in claim 11 that is fed the oxidized gas stream from an eluting chemical separation instrument, for the relative quantification of isotopes within compounds isolated thereby.

17. An IRMS described in claim 16 that is fed carbon dioxide derived from an eluting chemical separation instrument, for the relative quantification of carbon isotopes within compounds isolated thereby.

18. An IRMS described in claim 2, in which the collision cell and the following ion analysis units are maintained at the same voltage potential with respect to the ion selection unit.

19. An IRMS described in claim 2, in which the collision cell and vacuum chamber of the first analysis magnet receive variable voltage potentials with respect to the ion selection unit.

20. An IRMS described in claim 19 in which the voltage potential placed on the collision cell (144) is synchronized with the mass selection unit (125) so that the collision energy is optimized for 2 or more pairs of isotopes in succession.
